(19) United States
(12) Patent Application Publication
(10) Pub. No.: US 2010/0128967 A1
(43) Pub. Date: May 27, 2010

(54) Hands-free Inspection Systems

(76) Inventor: Jhobe Steadman, (US)

Correspondence Address: Jhobe Steadman, 11743 Aspen View Drive, San Diego, CA, 92128, US

(21) Appl. No.: 12/613,507

(22) Filed: Nov. 5, 2009

Related U.S. Application Data
(60) Provisional application No. 61/198,443, filed on Nov. 6, 2008.

(51) Int. Cl. G06K 9/00

(52) U.S. Cl. 382/141

(57) ABSTRACT

An inspection system comprising one or more foot switches, one or more data sources and computer software for the purpose of reducing manual procedures in an inspection process. Said inspection system is interfaced to a host computer and an inspection apparatus such that information regarding inspection of articles- or features-of-interest can be recorded in an inspection report. Said inspection system data sources may include, but are not limited to, position determination devices, information reading devices, voice input devices in combination with voice recording or voice recognition software, image capture devices and/or their associated software, and foot switches. Said computer software being a standalone application, with or without associated files, or a file executed by a separate software application, again, with or without associated files.

### CROSS-REFERENCE TO RELATED APPLICATIONS

This application claims the benefit of PPA Ser. No. U.S. 61/198,443, filed Nov. 6, 2008.

### BACKGROUND

1. Field of Invention

The present invention relates to inspection technology. In particular, the present invention relates to improvements in speed, accuracy, functionality, ease-of-use, and ergonomics in the inspection systems.

2. Prior Art

Inspection systems and procedures exist throughout most industries, ranging from visual inspection procedures without hardware devices or documentation to highly precise automated instrumental inspection systems accompanied by automated recording procedures. For non-automated inspection procedures, there exists a need for faster, more accurate, easier to use, more ergonomic integrated inspection systems which incorporate multiple functionalities. Current manual inspection processes oftentimes involve numerous processes including visually examining the item of interest, manipulating it manually, reading instruments, writing down or typing observations, taking pictures, etc. These processes are usually not well integrated and require substantial user effort. The inspection system described in this patent addresses several aspects of the manual inspection process including 1) reading and recording information regarding identification of the sample; 2) determining and recording locations of features-of-interest (FOI); 3) describing these features-of-interest in the inspection record; 4) acquiring images of the FOI's and embedding these images or links to them in the inspection record; 5) recording the number of instances a particular FOI occurs; and 6) making these processes faster, easier, and more ergonomic.

The specific case of inspecting samples on microscope slides on a microscope follows as an example of an inspection process. In microscopy, the microscopist typically has one hand operating the mechanisms for moving the sample stage in the horizontal directions (x and y) and the other hand operating the vertical (z) focus mechanism for the sample stage. Although there are microscope systems with video display generated by an attached camera, the large majority of microscopes require the microscopist to view the sample through oculars. From this description, it is clear that both of the microscopist's hands are being used and that it is inconvenient, time-consuming, and not ergonomic for them to be removing their hands or eyes from the microscope controls and oculars to manually perform other tasks. These same concerns apply to other inspection processes in many different industries, including but not limited to medical devices and electronics. For example, manufacturing and quality control processes share many of these concerns.

Recording information regarding the sample identification, is an extremely important aspect of medical devices, diagnostics, biotech, manufacturing and quality control inspection processes. This is especially important due to HIPAA (Health Insurance Portability and Accountability Act) patient confidentiality concerns. As a result, bar coding of samples is prevalent in these industries and accurately recording these barcodes in an inspection report is of paramount importance. Due to the possibility of incorrectly reading and recording the barcode information, visually reading and manually recording barcode information into an inspection report is a highly undesirable method.

A microscope typically has scales on the x- and y- axes of the mechanical sample stage. Microscopists interpolate x and y stage positions by comparing the graduations on the moving and non-moving parts of each stage axis. There are several disadvantages of this process including the fundamental inaccuracy of interpolating the position by comparing the two graduated scales. Also, reading the scales requires the microscopist to bend over the table in order to get close enough to these scales to read them. The interpolation process also takes considerable time. Lastly, but importantly in the medical and biotechnology fields, many microscopy applications use fluorescent dyes in the samples. These fluorescent dyes bleach when exposed to light. To prevent this, microscopy of these samples is often conducted in darkened rooms. This makes reading the graduated scales on the microscope stage even more difficult, oftentimes requiring the microscopist to use a small, low-power flashlight to illuminate the scales.

Once a microscopist has located a feature-of-interest, they often are required to record the x, y (and possibly z) location of the feature-of-interest and their comments or descriptions regarding the feature in an inspection report. This is typically done by hand, either writing the locations and comments on an inspection report or typing this information into a computer report. Several inadequacies result from this manual process. First, the microscopist must turn away from the microscope and use his hands to write the information in a written report or to type the information into a computer-generated report. Secondly, recording errors are possible wherein the microscopist records an incorrect value or sign (positive or negative). Thirdly, the microscopist may enter the information in the incorrect location on the inspection form. Lastly, this process requires considerable time, especially when the microscopist wishes to record extensive observations regarding the feature-of-interest.

Acquiring images of the feature-of-interest requires a camera integrated to the inspection system (microscope in this preferred implementation). The image acquisition software is usually specific to the camera although there are standards which attempt to harmonize these processes (Twain compliant hardware). Most camera systems software is focused predominately on acquiring images, not recording additional information such as comments or location coordinates. As such, even if the microscopist is recording comments into a computer software package, the camera software is usually a separate software application and acquired images are not associated to or with corresponding data in the inspection report. As a result, integrating camera images into the inspection report is often a cumbersome process, more so if the inspection report is written rather than digital.

Lastly, there are numerous instances where a particular item or feature simply needs to be counted and recorded. For example, in microscopy one might want to count the number of a particular type of cell. In a manufacturing process, one might want to count the number of defective parts in a lot. Myriad additional examples exist. In these cases, one might keep the count “in one's head”, use a hand-held counter or make written marks on an inspection report. All of these methods have obvious disadvantages. The “keeping count in one's head” can not be rigorously validated or verified. The use of a hand-held counter is certainly plausible in situations where at least one hand is available, but is not convenient in the case of microscopy and numerous other inspection processes. Making marks on an inspection report is again, not convenient for processes wherein both hands are occupied. This method is also more time consuming than the others.

3. Objects and Advantages

The integrated hands-free inspection system disclosed herein eliminates many of the problems identified with the previously considered data sources and processes regardless of the particular field of the inspection (microscopy, manufacturing, quality control, etc.). Although implementing a foot switch to trigger a barcode reader may be considered obvious, the idea of creating a substantially hands-free inspection system integrating a plurality of foot switches, software, and a diverse set of data sources is not. The data sources, including some combination of barcode readers, position encoders, voice recorders, cameras, and counting devices, provide a wealth of information regarding the sample being inspected. Combined with the hands-free nature of the system, the inspection process becomes faster, easier, more accurate, more comprehensive and more ergonomic.

Although the capabilities and benefits are applicable to a wide variety of inspection processes, the following discussion regarding the specific example of microscopic inspection demonstrates the utility and benefits of the integrated hands-free inspection system proposed herein.

There are numerous inspection applications wherein each part to be manually inspected is barcoded. Substantial time, effort, and ergonomics improvements would be realized applying the inspection system described herein to these inspection applications. Inspection applications wherein an entire lot of parts or devices share a common barcode still benefit from the data integrity, ease-of-use and ergonomics achieved using the proposed hands-free inspection system.

Determining x, y, z positions on a microscope stage can be accomplished using optical, magnetic or laser encoders as well as other position or distance measurement devices. The outputs from these devices are often displayed on a visual readout. Any or all of the x, y, z coordinates data can be transferred to a computer through a computer interface incorporated directly into the measurement devices, in the visual readout(s), or in a separate computer interface module. Using a foot switch to actuate the transfer of coordinates from the devices or readout(s) to the computer allows the microscopist to not remove his hands from the microscope controls or his eyes from the microscope oculars. This has substantial benefits with regards to speed, ease-of-use and ergonomics. Also, the data is more accurate in that no reading or recording errors are possible. Obviously, the inspection system software must accomplish the reading and transfer of data, recording into the software application and any further data processing necessary.

As described previously, microscopists often need to describe features-of-interest quite extensively. The time and effort required to write or type these observations into the inspection report is substantial. This time and effort can be substantially decreased utilizing a foot switch to actuate voice-to-text (speech recognition) or voice recording software. Although speech recognition software is not perfect at this time, it is very good, has training capabilities and is constantly improving. Alternatively, or additionally, using a foot switch to actuate recording of the microscopist's observations into a sound file and then embedding this sound file, or a link to it, into the inspection record is also possible. Having the observations closely associated with the feature-of-interest coordinates also provides better data integrity.

Similar benefits result from using a foot switch to actuate image capture and/or image embedding/linking from a camera interfaced to the microscope into the inspection report. If the camera is Twain compliant, the software commands to cause image capture have been largely standardized, making the software coding more universal. Non-twain compliant camera systems will most probably require custom coding in the inspection system software. In either case, substantial time, effort and ergonomics improvements result from using a foot switch in this process. Again, having an image of the FOI closely associated in the inspection report with the corresponding coordinates and observations unifies the data about each feature-of-interest.

There are also instances when the foot switch itself may be used as a data source. As mentioned previously, counting applications serve as a common example. Using the foot switch obviates the need to keep count in one's head, manually write or use the computer keyboard to increment the count data in the inspection report.

Although microscopy has been discussed as a preferred implementation, the benefits of a hands-free information acquisition system are pertinent to many inspection systems in many industries and applications.

Further features and advantages of the present invention will become apparent to those of ordinary skill in the art in view of the detailed description of preferred embodiments below, when considered together with the attached drawings and claims.

### SUMMARY OF INVENTION

The present invention describes an integrated inspection system which improves existing systems by combining one or more data sources and software with a hands-free means of acquiring information from the data sources, resulting in increased speed, accuracy, functionality, ease-of-use and ergonomics. In particular, the inspection system incorporates computer software, one or more foot switches and one or more data sources, including selection from or combination of position monitoring, barcode reading, voice input, counting, and image acquisition devices.

### DESCRIPTION OF THE DRAWINGS

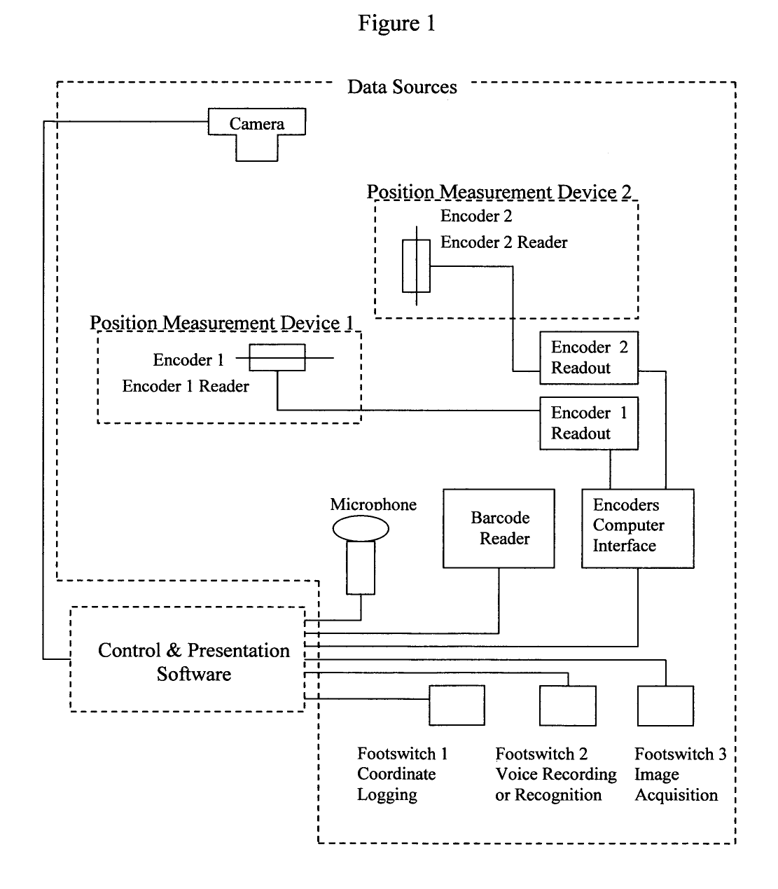

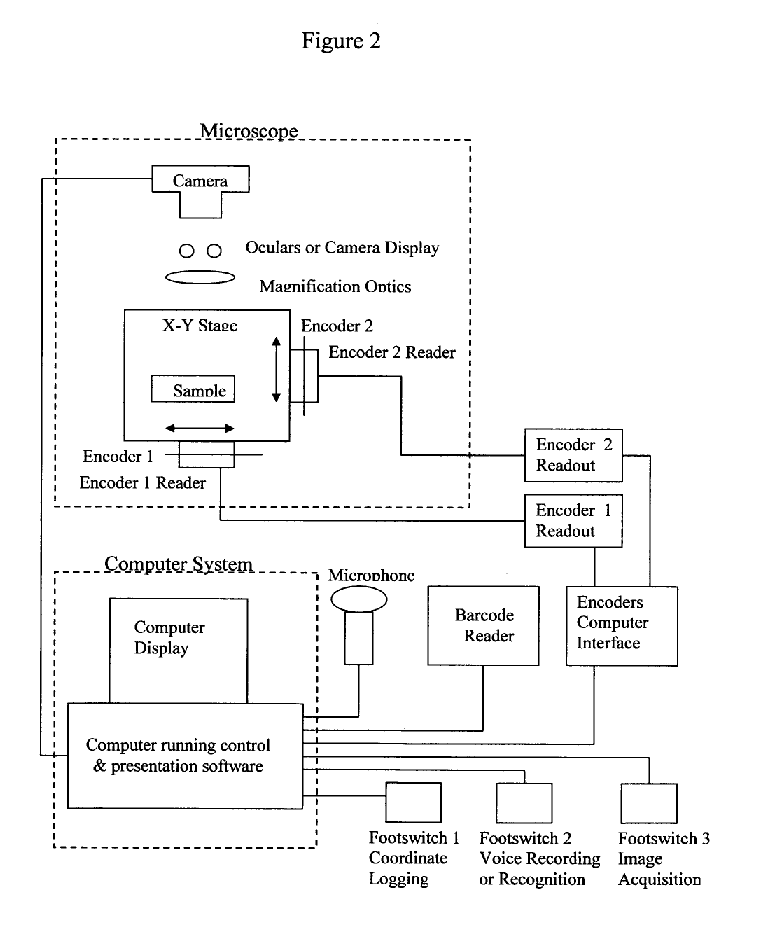

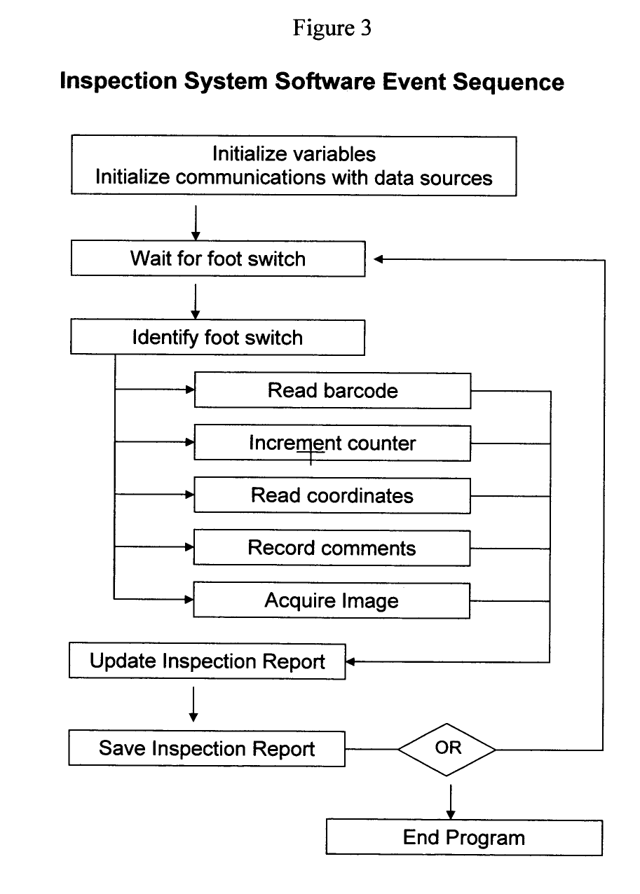

1. Components of the disclosed inspection system showing x- and y-axis position encoders having digital coordinate displays and a computer interface, barcode reader, microphone, camera, addressable footswitches and control and presentation software.
2. A microscope system imaging a sample on a movable stage with the inspection system components of FIG. 1 and x- and y-axis position encoders having digital coordinate displays and a computer interface, barcode reader, microphone, camera, addressable footswitches and a computer running the inspection system software.
3. Inspection System Software Event Sequence: flow diagram of hands free inspection and analysis software.

### DETAILED DESCRIPTION

The present invention provides for integration, improved capabilities, speed, accuracy, ease-of-use, and ergonomics for manual inspection processes by integrating one or more data sources into an inspection system which can be operated with minimal or no use of the operator's hands. The system is composed of one or more addressable foot switches, one or more data sources and a software program. In combination with the software, the addressable foot switches are used to actuate the acquisition, transfer, and/or recording of information from the data sources to the inspection report which is part of the software program. The data sources may include, but are not limited to, sample identification reading devices, position monitoring devices, voice recording and/or voice recognition software with a microphone input, image acquisition devices and/or their associated software, as well as the foot switches themselves, which might, for example, serve as counters in an inspection process. These data sources are interfaced to a control computer running the inspection system software program. The capabilities of the hands-free inspection system described herein are of substantial value in numerous inspection processes in numerous industries.

In the preferred embodiment, the inspection system described herein would be integrated with an optical microscope and computer system running some version of Microsoft Windows operating system. Additionally, Microsoft sound recorder and Excel with speech recognition would be necessary to achieve full functionality of the inspection system capabilities described herein. The samples would be microscope slides with a barcode identifier. The sample identification reading device would be a barcode reader. Linear encoders would be mounted to the sample stage of the microscope to determine coordinates of features-of-interest. A headset microphone interfaced to the computer would be worn by the user and used to record or transcribe observations about features-of-interest. A camera would be attached to the microscope with its associated software installed on the computer. All of the foot switches would be addressable such that the computer operating system could distinguish which had been pressed and the inspection system software could direct program execution accordingly. Although the preferred embodiment described herein describes a microscopy application with a computer running Microsoft Windows and Excel with various additional Microsoft software components, the same benefits could be achieved in other inspection apparatuses interfaced to computers running other operating systems.

Sample identification information would be read by a barcode reader attached to the inspection apparatus and interfaced to the computer. Any of the readily available optical, laser, or CCD barcode reader technologies would work for this application. Selection of the particular technology to implement would depend on barcode symbology, lighting, mounting constraints, cost, and other factors specific to the inspection system in question. In the preferred embodiment, reading of the barcode would be triggered by actuating a foot switch which is monitored by the software on the host computer. Alternatively, the barcode reader could be set to read continuously and actuating the appropriate foot switch would signal the software to accept the current reading being transmitted by the barcode reader. Although barcode reading would typically be performed only once per sample, eliminating the need for the operator to perform this process manually would make the process easier, faster, and more ergonomic. The information read by the barcode reader would enter the inspection report in a predefined location and could be used as part of the file name when the inspection report is saved.

Determining the location of a feature-of-interest would be accomplished using encoders attached to a moveable platform of the inspection apparatus. Linear, rotary, optical, laser and magnetic encoders are all used for determining absolute or relative positions and all of these technologies could be used in an inspection apparatus attached to the inspection system described herein. In the preferred embodiment, the moveable platform would be the sample stage of a microscope which holds and translates microscope slides under a magnifying objective. The movement of the sample would be measured by linear optical encoders and encoder readers on one or more axes of the sample stage. In the preferred embodiment, the coordinates information from the read heads would be displayed on digital displays, preferably backlit LCD's or LED's for viewing in low ambient light. The read heads would be interfaced to the control computer. Alternatively, if the encoder readings are only to be displayed on the computer, the read heads would interface directly to the computer without the digital displays. A foot switch, in combination with the system software, would actuate the transfer of coordinate information from the digital displays or read heads to the computer. This information would then be recorded in appropriate locations in the inspection report as directed by the inspection system software. This process would be accomplished without the user having to remove his hands or eyes from the inspection apparatus.

In many inspection processes there exists a need to document observations regarding features-of-interest about the sample being inspected. The inspection system described herein would allow the user to record voice comments or hyperlinks to audio files describing features-of-interest into the inspection report using a desk, clip-on or headset microphone as an input device to the computer system. In the preferred embodiment, wearing a headset microphone, the user would depress the appropriate foot switch actuating Microsoft's voice recognition software that accompanies Microsoft Office products. As the user speaks, his observations would be transcribed and recorded directly into the appropriate location in the inspection report. Releasing the foot switch would stop the voice recognition process and stop entry into the inspection report. This would allow the comments to be read at a later time directly from the inspection record. Note that the capabilities of voice recognition software are constantly improving and that most voice recognition software packages include the ability to “teach” new words which were not originally part of the software's vocabulary. In addition to, or in lieu of, performing only voice recognition to record observations into the inspection report, the software could be programmed such that pressing the foot switch activates Microsoft sound recorder which would record the user's observations to a sound clip (.wav or another audio format). Releasing the foot switch would stop the recording process and embed the sound clip directly into the inspection report, providing the ability to replay a recording of the user's observations by clicking the file link in the inspection report. Alternatively, the same foot switch could be programmed to save the sound clip to a sound file outside of the inspection report and a hyperlink to this sound file would be embedded in the inspection report rather than the sound clip itself. Clicking the hyperlink would still allow the user to replay the recorded observations. This method decreases the memory storage size of the inspection report.

If a camera is integrated to the inspection apparatus, images of features-of-interest or links to these images can also be acquired and stored in the inspection record using the inspection system claimed herein. Both CMOS and CCD cameras would work for the inspection system claimed herein. In the preferred embodiment, the user would depress the appropriate foot switch and the software program would acquire, transfer, and embed the acquired image into the inspection report using functions internal to the software program or its host program. For example, in the preferred embodiment claimed herein, the software program is an Excel spreadsheet with Visual Basic for Applications scripts and macros. On pressing the “acquire image” foot switch, the inspection system software would call functions with Microsoft Excel to acquire an image from a camera attached to the computer. This camera would have been previously installed and the software drivers for this camera would have been previously loaded. This method works well for Twain-compliant camera systems. Alternatively, for non-Twain compliant cameras, the foot switch actuation would direct the inspection system software to interact with the separate camera software to accomplish the image capture, transfer and embedding into the inspection report. In both of these scenarios, the inspection system software can store the acquired images apart from the inspection report and embed hyperlinks to these images in the inspection report, thereby decreasing the memory storage size of the inspection report.

The addressable foot switches used throughout this inspection system to actuate information acquisition and retrieval from data sources may also be used as data sources themselves. For example, in inspection processes where counting features-of-interest or other items is required, the inspection system software includes the capability to recognized designated foot switch actuations as counters and increment the corresponding count in the inspection report.

Because a plurality of foot switches may be incorporated in the described inspection system, the foot switches may be attached to a supporting structure which prevents them from moving relative to each other. In this way, the user can become accustomed to the location of each foot switch and reliably press the correct foot switch for the desired function. Also, because the inspection system described herein may require more universal serial bus (USB) ports than are available on a standard computer, it may be necessary to install a USB hub. These hubs provide additional USB ports that are still uniquely addressable. Most computer operating systems support up to sixteen unique USB addresses.

The software program described herein provides a template for an inspection report, initializes all the hardware communications interfaces, monitors the footswitches, performs the functions appropriate for each of the foot switches, records and presents the data in the inspection report, and saves the inspection document when the inspection process is complete. The software can be a standalone application with associated support files or a file which is executed by a separate application, again, with or without associated files. In the preferred implementation, the inspection system software is a MicroSoft Excel spreadsheet that has embedded Visual Basic for Applications (VBA) scripts and macros. The event sequence performed by this software is outlined following this detailed description.

The preferred embodiment described above includes all the functionalities that would, at this time, be expected to fully describe a sample being inspected. One could expect that not all of these functionalities would be required in all instances or that others may be required which are not enumerated herein. Inspectors can customize their system by selecting a subset of functionalities (imaging, voice recording, voice recognition, bar coding, manual and foot switch actuated processes) that would meet their specific needs. The present invention intends to cover such subsets and combinations. For example, an inspection system which includes all of the above excepting the image capture or image hyperlink embedding would be covered by the present invention as well as other subsets of the technologies listed in the preferred embodiment. Also, while the preferred embodiment specifies fluorescence in-situ hybridization, this combination of technologies could be equally applicable to a wide range of inspection processes in a wide range of industries including, but not limited to, medical devices manufacture, MEMS devices manufacture, electronics manufacturing, pathology sample inspection/analysis, urology sample inspection/analysis, other medical fields which require sample inspection/analysis as well as manufacturing in general.

Although the foregoing invention has been described in terms of certain preferred embodiments, other embodiments will be apparent to those of ordinary skill in the art and the skilled artisan will be able to readily adapt the disclosed methods and sensors to a particular use. Additionally, other combinations, omissions, substitutions and modifications will be apparent to the skilled artisan, in view of the disclosure herein. Accordingly, the present invention is not intended to be limited by the recitation of the preferred embodiments, but is instead to be defined by reference to the appended claims.

### Operation of the Invention

Installation of the system requires both hardware and software installation of the various components. For example, hardware installation of the position reading devices would require attaching the devices to the inspection apparatus such that they measure positions or movements of samples during the inspection process. In addition, the computer interface to the position reading devices must be plugged into the computer running the software program. The devices are typically plugged into the computer's universal serial bus (USB) ports; however, they can also be plugged into other computer communications ports including RS-232, firewire, parallel ports or proprietary interfaces. The same is true for a sample identification reading device (e.g., a barcode reader or scanner). It would have to be attached to the inspection system in a location which allows it to read the sample identification information when prompted by the software and it would have to be plugged into one of the computer's communications ports cited previously. Installation of the plurality of foot switches requires plugging each foot switch into a computer communications port. Other data sources may require mechanical mounting as well as connection to the host computer.

Because most of the anticipated data sources interface to the computer via USB ports, it is foreseeable that there would not be enough USB ports on a standard computer to accept all of the data sources. In this case, a USB hub can be attached to the computer which converts a single USB port into a plurality of USB ports, each still maintaining its unique address. The computer operating system typically allows up to sixteen unique USB ports to be defined.

As each of the data sources or their computer interface is plugged into the computer, the computer operating system will require the software drivers for these devices to be loaded. These drivers are provided by the manufacturer of the devices.

The inspection system software is installed on the computer in an appropriate directory or folder. This software may be an independent standalone program with or without associated support files, or a file which is run by another software application on the computer, again, with or without support files. In the preferred embodiment, the inspection system software is a Microsoft Excel file which has Visual Basic for Applications (VBA) macros and scripts associated with it such that when the inspection system software is run, the associated VBA macros and scripts also run.

The following would be a typical use of the claimed inspection system. When the computer is turned on, the computer operating system identifies all attached devices and determines how to communicate with them according to the software drivers loaded when the devices were first installed. When the inspection system software is run, the data sources are initialized, program variables are initialized and the inspection report template is presented to the user. In a typical inspection process, the user would begin acquisition of the sample barcode information by pressing the appropriate foot switch. The software would then cause the reader to read the sample barcode information, transfer it, and display it in the inspection report in a specified location. When a feature-of-interest (FOI) is observed, the user would depress a second foot switch which would read, transfer and display the coordinates of the FOI. Actuating a third foot switch would allow user observations, as dictated into a microphone interfaced to the computer, to be recorded or transcribed using voice recording or voice recognition software. The voice file, a link to the voice file or a transcription of the user's observations would then be entered into the inspection record. Actuating yet another foot switch would acquire, transfer, and store images acquired by a camera integrated to the inspection apparatus and computer, into the inspection report. Alternatively, links to these images could be embedded in the inspection report. One or more foot switches might also be used to count features observed in the inspection process. The inspection system software saves the inspection report after completing inspection of each feature-of-interest and when the entire inspection process is complete.

### Description and Operation of Alternative Embodiments

The inspection system claimed herein has application in a wide variety of industries, including but not limited to biotechnology, medical, manufacturing, quality control and general research. One alternative embodiment of the inspection system includes the specific integration of this inspection system with an optical microscope. Another alternative embodiment of the inspection system includes integration with parts inspection systems incorporating one-, two-, or three-axis inspection platforms.

### Conclusion, Ramifications, and Scope of Invention

In conclusion, the claimed integrated inspection system provides faster, more accurate, more comprehensive, more ergonomic information acquisition in an inspection process, regardless of the articles being inspected. The use of foot switches to actuate information acquisition, transfer and display allows the user to not have to remove their hands or eyes from the inspection apparatus. The process is faster, easier, more accurate and more ergonomic than manual inspection processes. Because the inspection process is faster, the user can inspect more parts per unit time, increasing inspection throughput. Because the process is easier, the user will not fatigue as quickly and will not make as many mistakes as with a manual process. Because the process results in direct transfer of information from the data sources to the inspection report, it is more accurate than manual methods. Because the user does not have to remove his hands or eyes from the inspection apparatus, the inspection process is more ergonomic.

1. A system comprising one or more footswitches, data sources, and computer software, for the purpose of acquiring information during an inspection process, substantially reducing the requirement of the inspection person's use of their hand or hands, wherein said footswitches are individually addressable such that a computer running said computer software recognizes which said foot switch has been actuated and executes computer code specific to said foot switch
a. The system of claim 1, wherein said computer code, executed as a result of actuation of said footswitch performs functions within said computer software to acquire information from said data sources
i. The system of claim 1a, wherein said data sources include devices having the function of determining the position of an object and communicating this information to a computer
ii. The system of claim 1a, wherein said data sources include a means of transmitting audible signals into said computer
iii. The system of claim 1a, wherein said data sources include a means of reading textual or symbolic information from objects being inspected into said computer
iv. The system of claim 1a, wherein said data sources include a means of transmitting visual images into said computer
v. The system of claim 1a, wherein said data sources include a means of counting features-of-interest
vi. The system of claim 1a, wherein said computer code is a file which can be opened and the included functions performed by Microsoft Excel
vii. The system of claim 1a, wherein said system is integrated with an optical microscope
b. The system of claim 1, wherein said computer code, executed as a result of actuation of said foot switch performs functions within said computer software not related to said data sources
c. The system of claim 1, wherein said computer code, executed as a result of actuation of said foot switch causes software which is not part of said system on said computer to retrieve, record and/or presentation information from one of said data sources

2. A means of acquiring information during an inspection process substantially reducing the requirement of the inspection person's use of their hand or hands comprising one or more footswitches, data sources, and computer software, wherein said footswitches are individually addressable such that a computer running said computer software recognizes which said foot switch has been actuated and executes computer code specific to said foot switch

3. A means of reducing the extent of a person's use of their hand or hands in an inspection process comprising one or more footswitches, one or more data sources, and computer software
